(19) United States
(12) Patent Application Publication
(10) Pub. No.: US 2008/0146314 A1
(43) Pub. Date: Jun. 19, 2008

(54) SLOT MACHINE

(75) Inventor: Kazumasa YOSHIZAWA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/954,313

(22) Filed: Dec. 12, 2007

(30) Foreign Application Priority Data
Dec. 15, 2006 (JP) 2006-339042

(51) Int. Cl. A63F 13/00

(52) U.S. Cl. 463/20

(57) ABSTRACT

The present invention provides a slot machine which awards a prize based on a unified symbol to be displayed across a plurality of displays, formed by divided symbols arranged on reels of the respective displays. A first upper reel 41 and a first lower reel 42 arranged on an upper display 5 and a second upper reel 43 and a second lower reel 44 arranged on a lower display 6 start rotating along with start of a game, and after a predetermined time elapses, a total of four divided symbols 25 are stopped and displayed in the symbol display areas 31 through 34, and as a result, particularly when a unified symbol 26 across the symbol display areas 31 through 34 is formed by the combination of the divided symbols 25 displayed, a prize based on the kind of the formed unified symbol is awarded to a player.

### RELATED APPLICATION

This application claims the priority of Japanese Patent Application No. 2006-339042 filed on Dec. 15, 2006, which is incorporated herein by reference.

### FIELD OF THE INVENTION

The present invention relates to a slot machine which awards a prize based on symbols displayed on a plurality of displays.

### DESCRIPTION OF THE RELATED ART

Conventionally, in a slot machine as a kind of game machines, a game is started in response to insertion of game media such as coins into the game machine, and a symbol row is subjected to variable display in a predetermined area, and stopped and displayed after a predetermined time elapses, and based on a combination of the stopped symbols, a prize is awarded.

Generally, it is judged whether the combination that causes a prize to be awarded is formed based on whether a predetermined number of symbols of the same kind (for example, “CHERRY” or “7”) are aligned along a payline set in advance. There is also a conventional case where a prize is awarded based on a combination that is not along the payline.

For example, in the specification of United States Patent Publication No. 6093102A1, a slot machine is described which displays a total of 15 symbols of 3×5 by using video reels or mechanical reels. In this slot machine, when a game is started, the reels rotate and symbols in rows aligned vertically start to be variably displayed in conjunction with the reels, and after a predetermined time elapses, according to stop of the rotation of the reels, three symbols are stopped and displayed in each row. Then, when the combination of the symbols stopped and displayed includes a predetermined number or more of symbols of the same kind, a prize is awarded. There is another slot machine as described in the specification of United States Patent Publication No. 6981635B1 which is improved in entertainment by displaying an effect image using symbols across a plurality of symbol display areas when symbols of the same kind are arranged in a plurality of symbol display areas adjacent to each other.

As conventional slot machines described above, a slot machine including a plurality of displays is also described. However, the number of displays including reels on which symbols are displayed is only one. That is, generally, among a plurality of displays of a slot machine, on displays other than the display that displays symbols, a help screen, a payout table, and effect image screens are displayed.

An object of the present invention is to provide a slot machine improved in entertainment by notifying a game result by using a symbol displayed on a plurality of displays.

### SUMMARY OF THE INVENTION

(1) A slot machine of the present invention includes: a controller which controls game progress; a first display including a first symbol display area which displays a symbol and a first reel which performs scrolling display of a plurality of symbols and stops and displays any one or a plurality of symbols in the first symbol display area; and a second display which includes a second symbol display area which displays a symbol in an area different from the first symbol display area and a second reel which performs scrolling display of a plurality of symbols and stops and displays any one or a plurality of symbols in the second symbol display area, and is provided separately from the first display, wherein the controller displays divided symbols obtained by dividing a unified symbol to be displayed across the first symbol display area and the second symbol display area into a predetermined division number, in the first symbol display area and the second symbol display area, and awards a prize when the unified symbol is formed by a combination of the divided symbols displayed in the first symbol display area and the second symbol display area.

(2) The slot machine according to (1) described above, wherein a unified symbol to be displayed across the first symbol display area and the second symbol display area is divided into a total number of the first reel and the second reel.

(3) The slot machine according to (1) described above, wherein the first reel and the second reel scroll a plurality of symbols leftward or rightward.

(4) A slot machine of the present invention includes: a controller which controls game progress; a first display including a first symbol display area which displays a symbol and a first reel which performs scrolling display of a plurality of symbols in a first direction and stops and displays any one or a plurality of symbols in the first symbol display area; and a second display which is aligned parallel to the first display in a second direction orthogonal to the first direction, includes a second symbol display area which displays a symbol in an area different from the first symbol display area, and a second reel which performs scrolling display of a plurality of symbols in the first direction and stops and displays any one or a plurality of symbols in the second symbol display area, and is provided separately from the first display, wherein the controller displays divided symbols obtained by dividing a unified symbol to be displayed across the first symbol display area and the second symbol display area into a predetermined division number, in the first symbol display area and the second symbol display area, and awards a prize when the unified symbol is formed by a combination of the divided symbols displayed in the first symbol display area and the second symbol display area.

(5) The slot machine according to (4) described above, wherein the first reel and the second reel scroll a plurality of symbols leftward or rightward.

(6) A slot machine of the present invention includes: a controller which controls game progress; a first display including a first symbol display area which displays a symbol and one or a plurality of first reels which perform scrolling display of a plurality of symbols in a first direction and stop and display any one or a plurality of symbols in the first symbol display area; and a second display which is aligned parallel to the first display in a second direction orthogonal to the first direction, includes a second symbol display area that displays a symbol in an area different from the first symbol display area and one or a plurality of second reels that perform scrolling display of a plurality of symbols in the first direction and stop and display any one or a plurality of symbols in the second symbol display area, and is provided separately from the first display, wherein the controller displays divided symbols obtained by dividing a unified symbol to be displayed across the first symbol display area and the second symbol display area into a total number of the first reel and the second reel, in the first symbol display area and the second symbol display area, and awards a prize when the unified symbol is formed by a combination of the divided symbols displayed in the first symbol display area and the second symbol display area.

(7) The slot machine according to (6) described above, wherein the first reel and the second reel scroll a plurality of symbols leftward or rightward.

In a slot machine of the present invention, a game result can be notified by using a larger symbol formed across a plurality of displays, and the slot machine can be improved in entertainment.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

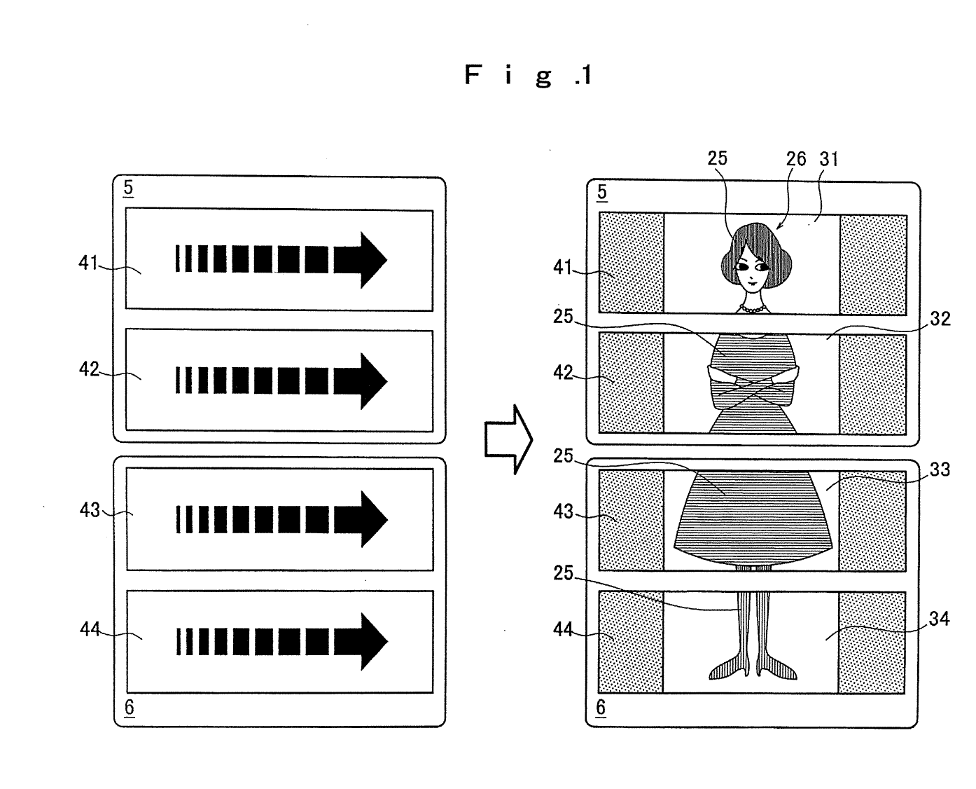

FIG. 1 is a drawing showing a characteristic portion of a slot machine of an embodiment of the present invention;

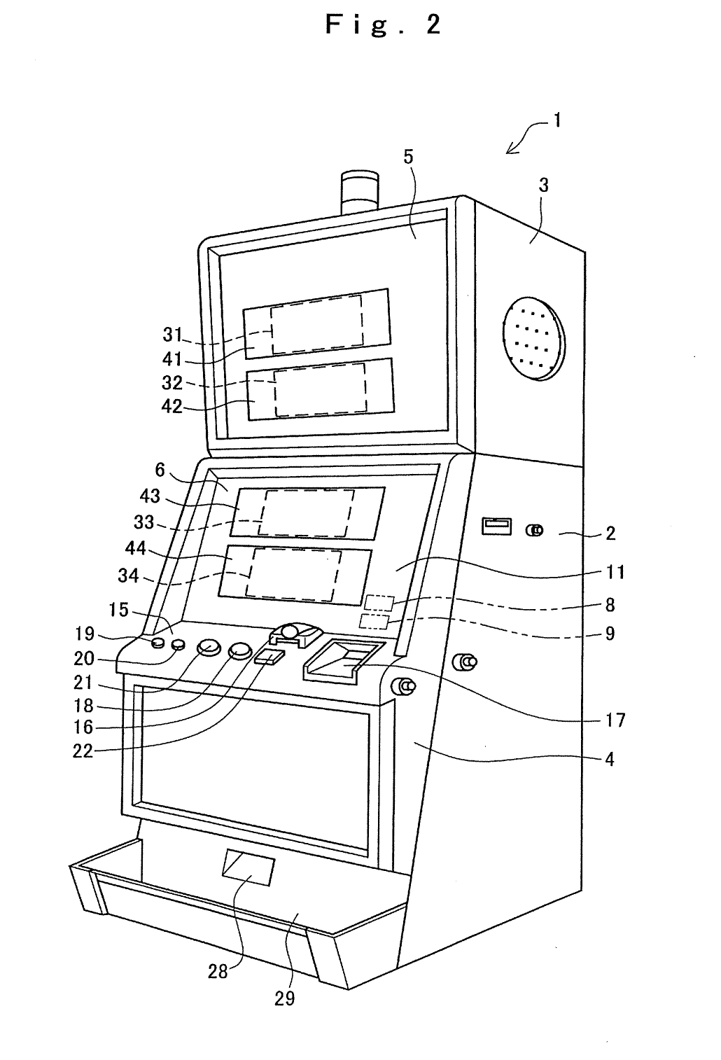

FIG. 2 is a perspective view showing an external view of the slot machine of this embodiment;

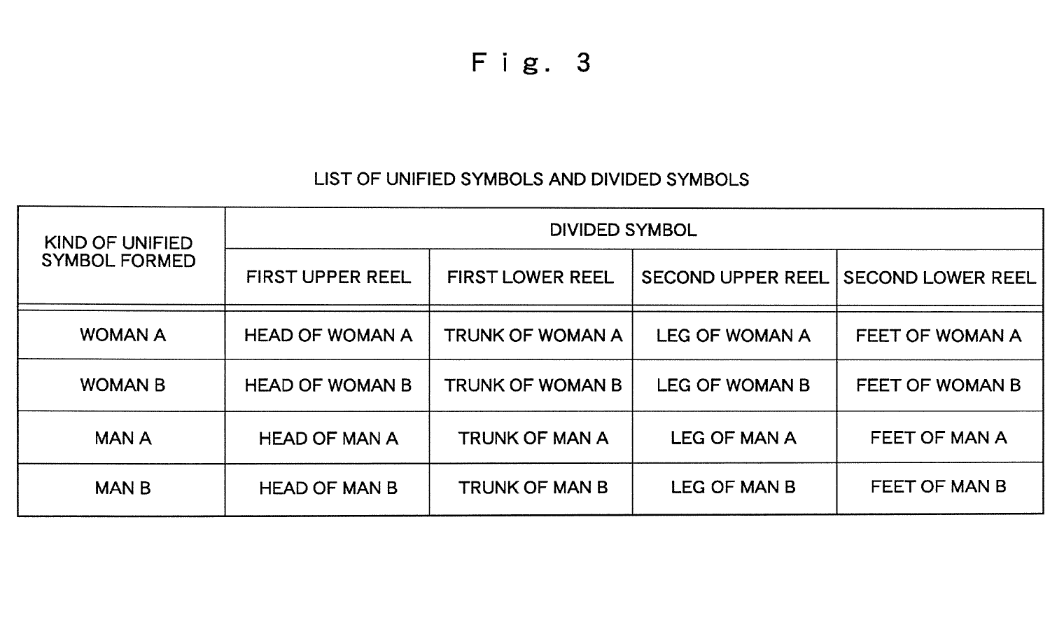

FIG. 3 is a diagram showing a list of unified symbols and divided symbols to be displayed in symbol display areas of an upper display and a lower display in the slot machine of this embodiment;

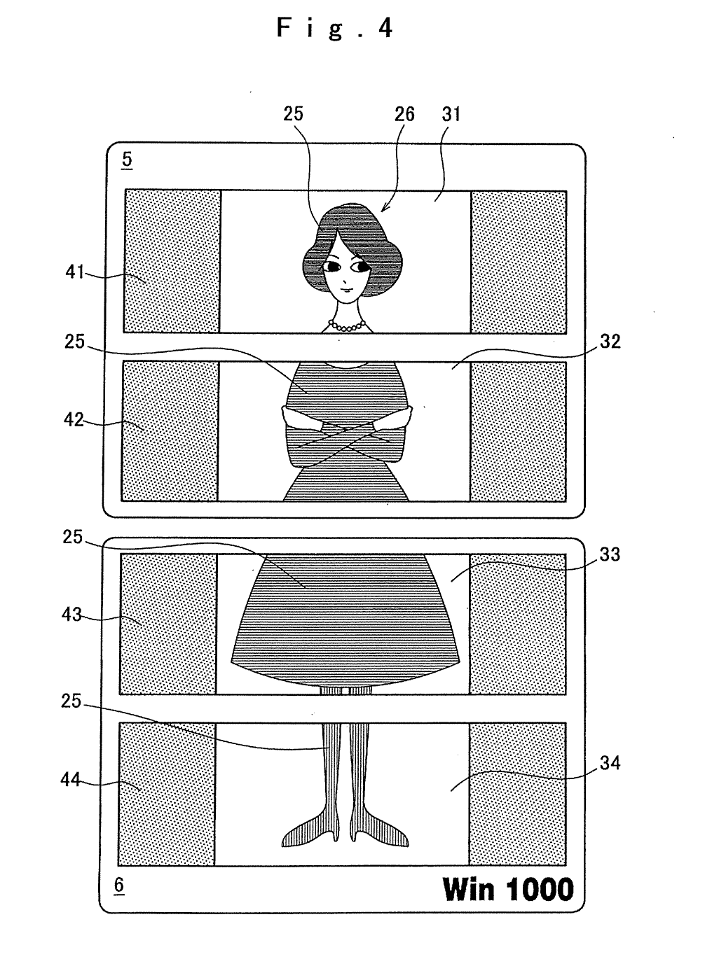

FIG. 4 is a drawing showing symbol display areas 31 through 34 when a unified symbol of “Woman A” is formed;

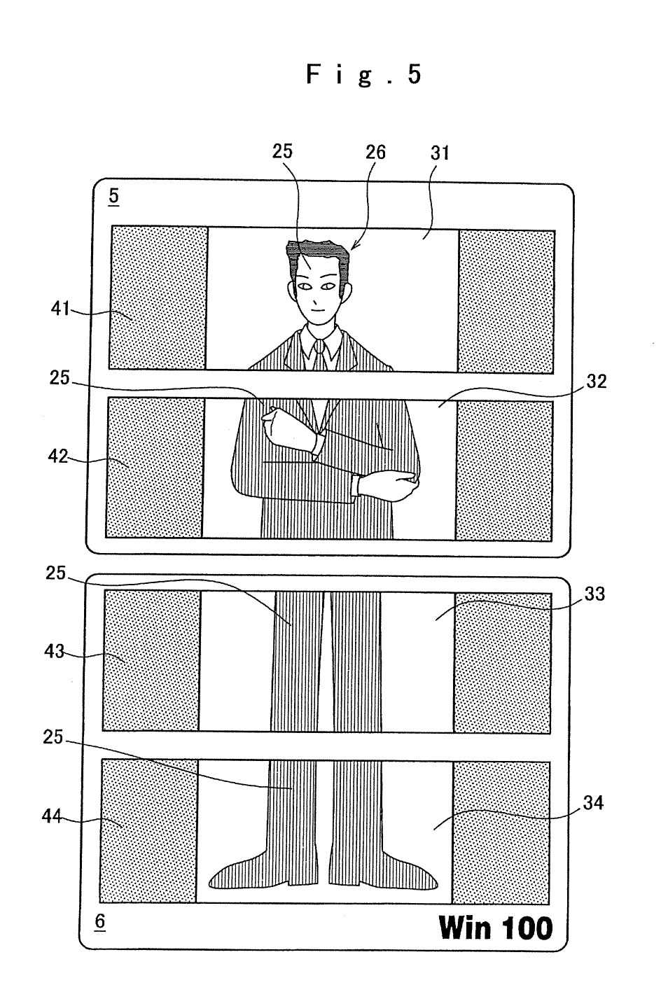

FIG. 5 is a drawing showing symbol display areas 31 through 34 when a unified symbol of “Man A” is formed;

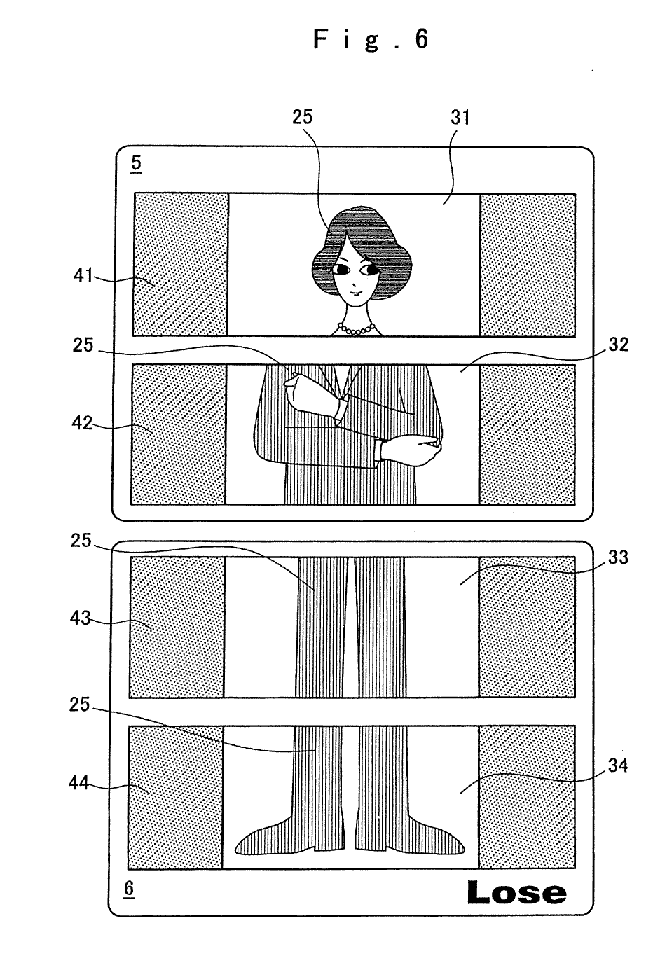

FIG. 6 is a drawing showing symbol display areas 31 through 34 when no unified symbol is formed;

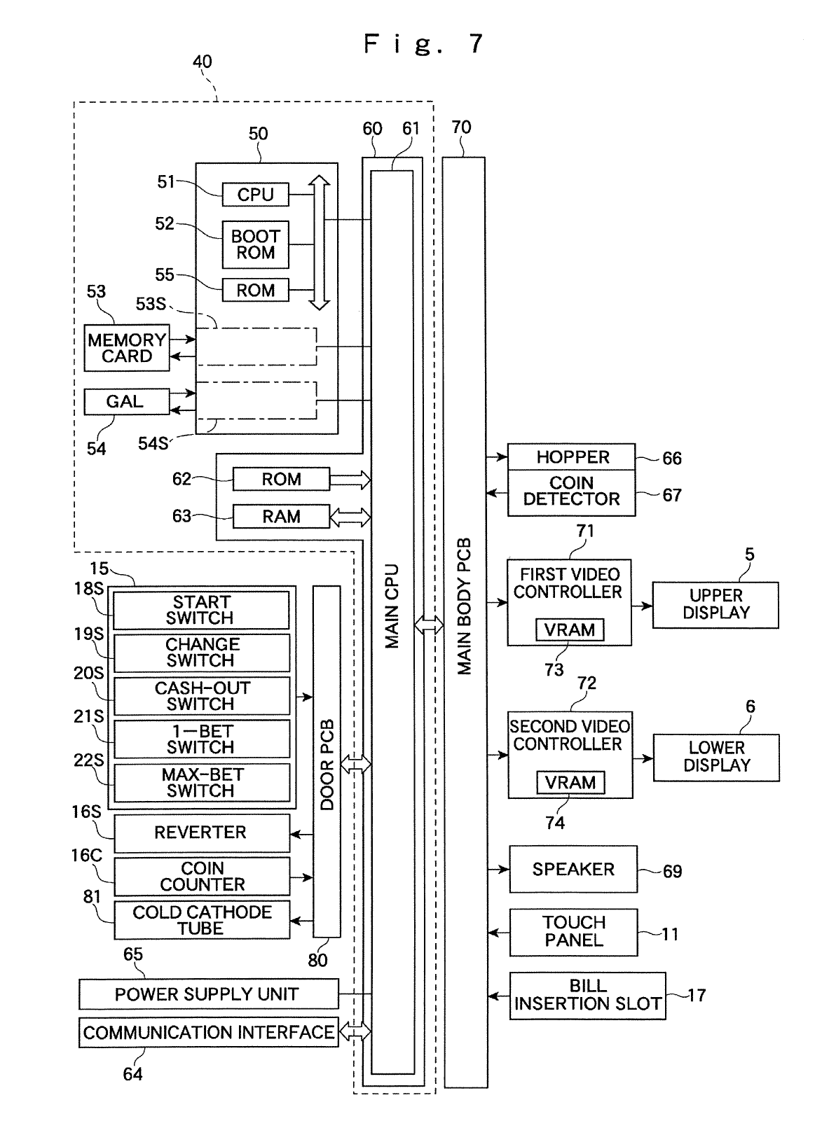

FIG. 7 is a block diagram schematically showing a control system of the slot machine of this embodiment;

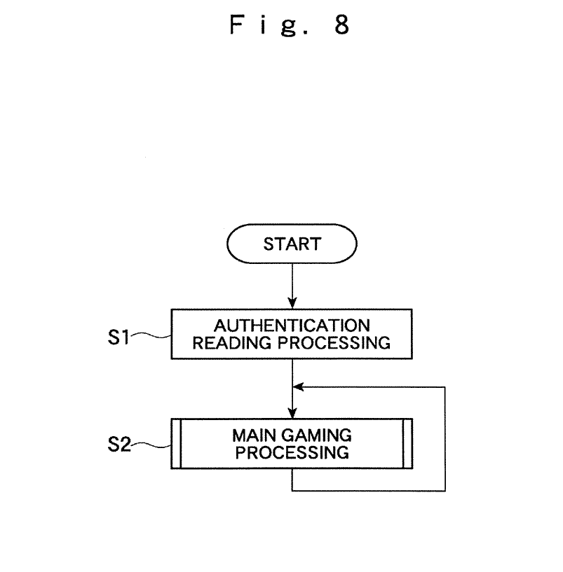

FIG. 8 is a flowchart of a main control processing program in the slot machine of this embodiment; and

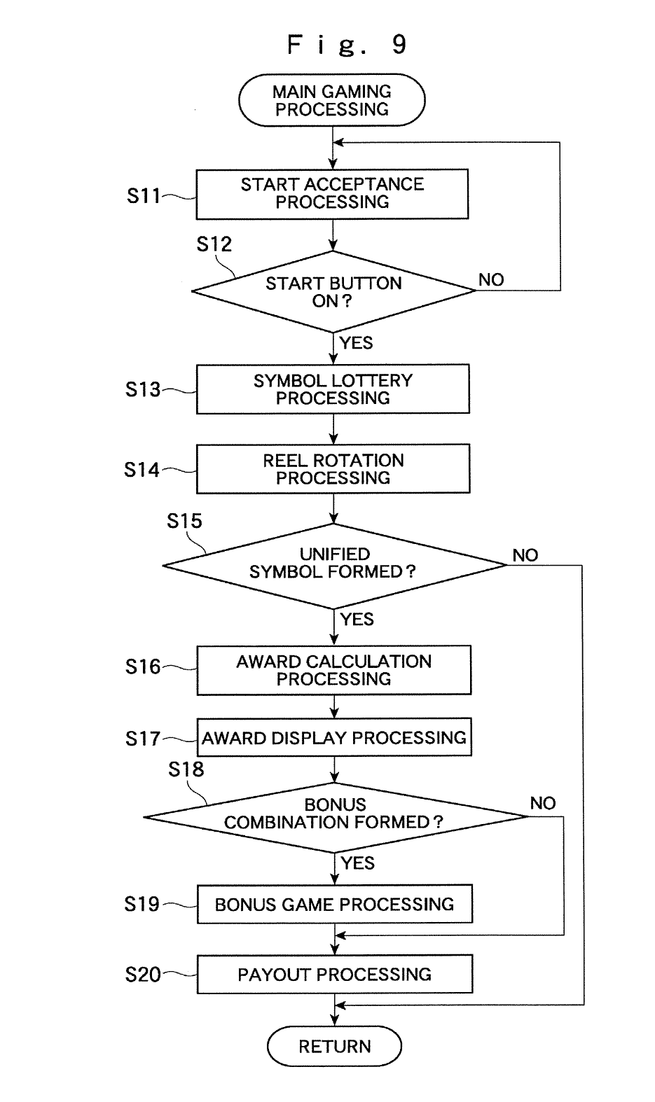

FIG. 9 is a flowchart of a main gaming processing program in the slot machine of this embodiment.

### DESCRIPTION OF THE PREFERRED EMBODIMENTS

A slot machine (for example, slot machine 1) of the present invention includes: a controller (for example, controller 40) which controls game progress; a first display (for example, upper display 5) including a first symbol display area (for example, symbol display areas 31 and 32) which displays a symbol and a first reel (for example, first upper reel 41 and first lower reel 42) which performs scrolling display of a plurality of symbols and stops and displays any one or a plurality of symbols in the first symbol display area; and a second display (for example, lower display 6) which includes a second symbol display area (for example, symbol display areas 33 and 34) which displays a symbol in an area different from the first symbol display area and a second reel (for example, second upper reel 43 and second lower reel 44) which performs scrolling display of a plurality of symbols and stops and displays any one or a plurality of symbols in the second symbol display area, and is provided separately from the first display, wherein the controller displays divided symbols (for example, divided symbols 25) obtained by dividing a unified symbol (for example, unified symbol 26) to be displayed across the first symbol display area and the second symbol display area into a predetermined division number, in the first symbol display area and the second symbol display area, and awards a prize when the unified symbol is formed by a combination of the divided symbols displayed in the first symbol display area and the second symbol display area.

According to the slot machine constructed as described above, a prize is awarded when a unified symbol to be displayed across the first symbol display area and the second symbol display area is formed by a combination of divided symbols displayed in the first symbol display area provided on the first display and the second symbol display area provided on the second display, so that a game result can be notified by using the symbol with a larger size formed across the plurality of displays. Thereby, the entertainment of the slot machine is improved. Even without increasing the size of the display for displaying symbols, a game result can be notified by using a symbol with a larger size, so that the entertainment can be remarkably improved in a minimum installation space while keeping the manufacturing cost of the slot machine low.

The slot machine of this embodiment can be further constructed so that a first direction of scrolling symbols on the first reel (for example, first upper reel 41 and first lower reel 42) and the second reel (for example, second upper reel 43 and second lower reel 44) and a second direction of aligning the first display (for example, upper display 5) and the second display (for example, lower display 6) are orthogonal to each other.

According to the slot machine constructed as described above, the scrolling direction of the symbols on the first reel and the second reel and the alignment direction of the first display and the second display are orthogonal to each other, so that a unified symbol can be formed like a photo montage by a combination of divided symbols obtained by dividing the unified symbol at predetermined intervals in the second direction.

The slot machine of this embodiment can be further constructed so that divided symbols (for example, divided symbols 25) obtained by dividing a unified symbol (for example, unified symbol 26) to be displayed across the first symbol display area (for example, symbol display areas 31 and 32) and the second symbol display area (for example, symbol display areas 33 and 34) into a total number of the first reel (for example, first upper reel 41 and first lower reel 42) and the second reel (for example, second upper reel 43 and second lower reel 44), are displayed in the first symbol display area and the second symbol display area.

According to the slot machine constructed as described above, the unified symbol is formed by using the divided symbols arranged on the same number of reels as the division number of the unified symbol, so that in response to various effects using all reels, a symbol with a larger size can be displayed on the displays.

The slot machine of this embodiment can be further constructed so that the first reel (for example, first upper reel 41 and first lower reel 42) and the second reel (for example, second upper reel 43 and second lower reel 44) scroll a plurality of symbols leftward or rightward.

According to the slot machine constructed as described above, a unified symbol is formed by divided symbols scrolled leftward or rightward, so that the unified symbol can be formed like a photo montage by the divided symbols changing horizontally.

Hereinafter, an embodiment of the slot machine of the present invention will be described with reference to the drawings. Herein, the slot machine of the embodiment described below is a so-called video slot machine which includes a display device such as a liquid crystal display and performs a game by displaying images of various symbols on the display device.

The slot machine of the present invention has an upper display 5 and a lower display 6 aligned parallel vertically, and on each display, a reel on which symbols are subjected to scrolling display is provided. Furthermore, when a symbol across the upper display 5 and the lower display 6 is formed by combining symbols arranged on the respective reels, a prize is awarded.

For example, in the slot machine shown in FIG. 1, the upper display 5 is provided with two reels 41 and 42 which rotate in the left and right direction to perform scrolling display of symbols, and on the other hand, the lower display 6 is also provided with two reels 43 and 44 which rotate in the left and right direction to perform scrolling display of symbols. On the reels, divided symbols 25 obtained by dividing a symbol into the number of reels are arranged.

When a game is started in the slot machine shown in FIG. 1, on the respective reels 41 through 44, scrolling display of symbol rows is performed. When a predetermined time elapses, the reels 41 through 44 stop rotating in a predetermined order so that one divided symbol 25 is stopped and displayed on each of the symbol display areas 31 through 34. As a result, as shown in FIG. 1, when a combination of four divided symbols 25 stopped in the respective symbol display areas 31 through 34 newly forms a unified symbol 26 of “Woman” displayed a cross all symbol display areas 31 through 34, a prize based on the formation of the unified symbol 26 of “Woman” is awarded.

First, a general construction of the slot machine 1 according to this embodiment will be described based on FIG. 2. FIG. 2 is an external perspective view of the slot machine 1 of this embodiment.

The slot machine 1 of this embodiment includes a cabinet 2, a top box 3 set on the cabinet 2, and a main door 4 provided on the front face of the cabinet 2.

On the front face of the top box 3, an upper display 5 is provided. The upper display 5 includes a generally known liquid crystal display and includes two symbol display areas 31 and 32. The upper display 5 also includes a first upper reel 41 which performs scrolling display of a predetermined symbol row and stops and displays any one of the symbols in the symbol display area 31, and a first lower reel 42 which performs scrolling display of a predetermined symbol row and stops and displays any one of the symbols in the symbol display area 32. Then, as described later, according to the progress of the game, a total of four symbols at maximum combined with symbols on the symbol display areas 33 and 34 of the lower display 6 are displayed. When a unified symbol 26 across the symbol display areas 31 through 34 is formed by the combination of the four symbols is displayed, a predetermined prize is awarded to a player. The scrolling direction (for example, horizontal direction) of symbols on the first upper reel 41 and the first lower reel 42 cross the alignment direction (for example, vertical direction) of the upper display 5 and the lower display 6.

On the other hand, on the entire surface of the main door 4, a lower display 6 is provided. Herein, the lower display 6 includes a generally known liquid crystal display and includes two symbol display areas 33 and 34. The lower display 6 also includes a second upper reel 43 which performs scrolling display of a predetermined symbol row and stops and displays any one of the symbols in the symbol display area 33, and a second lower reel 44 which performs scrolling display of a predetermined symbol row and stops and displays any one of the symbols in the symbol display area 34. Then, as described later, according to the progress of the game, a total of 4 symbols at maximum combined with symbols on the symbol display areas 31 and 32 of the upper display 5 are displayed. When the unified symbol 26 across the symbol display areas 31 through 34 is formed by the combination of the four symbols displayed, a predetermined prize is awarded to the player. The scrolling direction (for example, horizontal direction) of symbols on the second upper reel 43 and the second lower reel 44 is a direction crossing the alignment direction (for example, vertical direction) of the upper display 5 and the lower display 6.

Herein, the number of reels to be provided on the upper display 5 and the lower display 6 may be 3 or 5, and the number of symbol display areas in which symbols are displayed by each reel may be 2 or more.

On the front face of the lower display 6, a touch panel 11 is provided, and a player can input various instructions by operating the touch panel 11.

Furthermore, on the lower display 6, a credit number display unit 8 and a payout number display unit 9 are provided. On the credit number display unit 8, the number of credits that the player currently has is displayed. On the payout number display unit 9, an amount of a prize to be awarded when the combination of symbols stopped and displayed on a symbol display unit 7 is a predetermined winning combination is displayed as a payout number.

At the lower side of the lower display 6, a control panel 15 on which a plurality of buttons for inputting instructions relating to the game progress by a player are arranged, a coin receiving opening 16 for receiving coins as game media into the cabinet 2, and a bill insertion slot 17 are provided.

On the control panel 15, a start button 18, a change button 19, a CASH-OUT button 20, a 1-BET button 21, and a MAX-BET button 22 are provided. The start button 18 is an operating unit for inputting an instruction to start scrolling display of symbol rows on the reels 41 through 44. The change button 19 is an operating unit to be used for requesting staff of a game arcade to change money. The CASH-OUT button 20 is an operating unit for inputting an instruction to pay-out coins corresponding to the number of credits that the player has (one credit corresponds to one coin) from a coin payout opening 28 to a coin tray 29, or an instruction to pay-out a barcode ticket.

The 1-BET button 21 is an operating unit for accepting an instruction to bet one credit for a game among the credits that the player has. The MAX-BET button 2 is an operating unit for accepting an instruction to bet the maximum number of credits that can be bet for one game (in this embodiment, 50 credits) of the credits that the player has for the game. As BET buttons, various BET buttons such as a 3-BET button can be additionally provided.

In the slot machine 1 of this embodiment, as game media, coins, bills, or electronic value information (credits) corresponding to the coins and bills are used. However, game media applicable to the present invention are not limited to these, and for example, medals, tokens, electronic money, and tickets, etc., can also be used.

Subsequently, based on FIG. 3 through FIG. 6, symbols to be displayed in the symbol display areas 31 through 34 of the upper display 5 and the lower display 6 in a game will be described.

Herein, in the slot machine 1 of this embodiment, symbols to be displayed in the symbol display areas 31 through 34 of the upper display 5 and the lower display 6 include a unified symbol 26 and divided symbols 25. FIG. 3 shows a list of unified symbols 26 and divided symbols 25 to be displayed in the symbol display areas 31 through 34 of the upper display 5 and the lower display 6 in the slot machine of this embodiment.

The unified symbol 26 is a large-sized symbol to be displayed across the symbol display areas 31 through 34 of the upper display 5 and the lower display 6, and is formed by four divided symbols 25 stopped and displayed in the respective symbol display areas 31 through 34. There are four types (“Woman A,” “Woman B,” “Man A,” and “Man B”) of unified symbols 26 as shown in FIG. 3, and when a unified symbol 26 is formed by corresponding four divided symbols 25, a prize based on the kind of the formed unified symbol 26 is awarded. FIG. 4 shows a case where the unified symbol 26 of “Woman A” is formed, and FIG. 5 shows a case where the unified symbol 26 of “Man A” is formed.

On the other hand, the divided symbols 25 are small-sized symbols obtained by dividing the unified symbol 26 into quarters vertically. As shown in FIG. 3, on the first upper reel 41, among a total of 16 kinds of divided symbols 25 obtained by dividing four kinds of unified symbols 26 into quarters, four kinds of divided symbols 25 indicating the head portions of the respective characters are scrolled and displayed, and any one kind of divided symbol 25 determined by internal lottery is stopped and displayed in the symbol display area 31. On the first lower reel 42, four kinds of divided symbols 25 indicating trunk portions of the respective characters are scrolled and displayed, and any one kind of divided symbol 25 determined by internal lottery is stopped and displayed in the symbol display area 32. On the second upper reel 43, four kinds of divided symbols 25 indicating leg portions of the respective characters are scrolled and displayed, and any one kind of divided symbol 25 determined by internal lottery is stopped and displayed in the symbol display area 33. On the second lower reel 44, four kinds of divided symbols 25 indicating foot portions of the respective characters are scrolled and displayed, and any one kind of divided symbols 25 determined by internal lottery is stopped and displayed in the symbol display area 34.

Then, as shown in FIG. 4 and FIG. 5, when divided symbols 25 which are divisions of the same kind of character are all stopped and displayed in the symbol display areas 31 through 34 and, as a result, the unified symbol 26 is formed, the game is won and a prize based on the kind of the symbol is awarded. On the other hand, as shown in FIG. 6, when divided symbols 25 as divisions of a plurality of kinds of characters are mixed and stopped and displayed in the symbol display areas 31 through 34 and, as a result, the unified symbol 26 is not formed, the game is lost and no prize is awarded. In particular, when the unified symbol 26 of “Woman A” is formed, as a prize, a bonus game is continuously executed after the end of the normal game.

Subsequently, game progress procedures of the slot machine 1 of this embodiment will be described in detail. First, when the start button 18 is depressed after finishing bet acceptance, internal lottery processing for determining divided symbols 25 to be displayed in the symbol display areas 31 through 34 is performed. Subsequently, when a predetermined time elapses since the depression of the start button 18, the reels 41 through 44 start rotating and perform scrolling display of symbol rows, and after a predetermined time elapses, a total of four divided symbols 25 or blanks are stopped and displayed in the symbol display areas 31 through 34. Then, when the unified symbol 26 is formed by the combination of the stopped and displayed divided symbols 25, contents of a prize are determined based on the kind of the unified symbol 26 formed, and the prize is awarded.

Next, a construction of a control system of the slot machine 1 of this embodiment will be described based on FIG. 7. FIG. 7 is a block diagram schematically showing a control system of the slot machine 1 of this embodiment.

As shown in FIG. 7, the control system of the slot machine 1 basically includes a mother board 60 and a gaming board 50. The mother board 60 and the gaming board 50 constitute a controller 40 which executes the control program described later (FIG. 8 and FIG. 9), etc.

First, the gaming board 50 is described. The gaming board 50 includes a CPU 51, a ROM 55, and a boot ROM 52 connected to each other by internal buses, a card slot 53S for a memory card 53, and an IC socket 54S for a GAL (Generic Array Logic) 54.

The memory card 53 includes a non-volatile memory, and is a recording medium on which a game program and a game system program (hereinafter, referred to as a game program, etc.) are recorded. The game program recorded on the memory card 53 includes a lottery program. This lottery program is for determining symbols to be displayed in the symbol display areas 31 through 34.

The memory card 53 includes a symbol sortition table for selecting symbols to be displayed in the symbol display areas 31 through 34 by lottery. Herein, the symbol sortition table is a table in which predetermined random number ranges are associated with the four kinds of divided symbols 25 (see FIG. 3) and blanks to be stopped and displayed in the symbol display areas 31 through 34 for each reel. First, the divided symbols 25 to be displayed in the symbol display areas 31 through 34 are selected by lottery based on the symbol sortition table, and thereafter, based on the combination of the determined divided symbols 25, a prize to be awarded to a player is determined.

As the symbol sortition table, a table which associates predetermined random number ranges with prizes to be awarded to the player may be used. In this case, first, a prize to be awarded to a player is selected by lottery based on the symbol sortition table, and a combination of divided symbols 25 that corresponds to the determined prize is selected by the main CPU 61.

Subsequently, the mother board 60 will be described. The mother board 60 is formed of a general-purpose mother board available on the market (a printed circuit board on which basic components of a personal computer are mounted), and includes a main CPU 61, a ROM 62, a RAM 63, and a communication interface 64.

The ROM 62 includes a memory device such as a flash memory and stores permanent data such as programs of BIOS, etc., to be executed by the main CPU 61. When the BIOS is executed by the main CPU 61, predetermined peripheral devices are initialized, and import processing of the game program, etc., stored in the memory card 53 is started via the gaming board 50.

The RAM 63 stores data and programs to be used when the main CPU 61 operates. In addition, the RAM 63 can store various programs such as an authentication program and the game program, etc., to be read out via the gaming board 50, and various information such as the number of credits that the player currently has.

The communication interface 64 is a communication device for communicating with a server, etc., installed in the game arcade via a communication line.

To the mother board 60, a main body PCB 70 and a door PCB 80 described later are connected by USB, respectively. Furthermore, to the mother board 60, a power supply unit 65 is connected. When power is supplied to the mother board 60 from the power supply unit 65, the main CPU 61 of the mother board 60 is started. Furthermore, power is supplied to the gaming board 50 via a PCI bus and the CPU 51 is started.

To the main body PCB 70, a hopper 66, a coin detector 67, a first video controller 71, a second video controller 72, a speaker 69, a touch panel 11, and a bill insertion slot 17, etc., are connected.

The first video controller 71 includes a VRAM 73, and controls image display on the upper display 5 based on a control signal from the main CPU 61. The second video controller 72 includes a VRAM 74, and controls image display on the lower display 6 based on a control signal from the main CPU 61. On the upper display 5, scrolling display and stopping display of the divided symbols 25 along with the rotations of the first upper reel 41 and the first lower reel 42 are performed. On the lower display 6, scrolling display and stopping display of the divided symbols 25 along with the rotations of the second upper reel 43 and the second lower reel 44 are performed.

Herein, in the slot machine 1 of this embodiment, the controller 40 works as a synchronization controller, whereby the upper display 5 and the lower display 6 can be controlled as one display surface. The synchronization controller may be constructed separately from the controller 40, and in this case, the synchronization controller is connected to the main body PCB 70.

On the other hand, to the door PCB 80, a control panel 15, a reverter 16S, a coin counter 16C, and a cold cathode tube 81 are connected. On the control panel 15, a start switch 18S respondent to the start button 18, a change switch 19S respondent to the change button 19, a CASH-OUT switch 20S respondent to the CASH-OUT button 20, a 1-BET switch 21S respondent to the 1-BET button 21, and a MAX-BET switch 22S respondent to the MAX-BET button 22 are provided. Each switch outputs an input signal to the main CPU 61 when a corresponding button is operated by a player.

Subsequently, a main control program to be executed in the slot machine 1 of this embodiment will be described in detail with reference to the drawings. FIG. 8 is a flowchart of the main control program.

It is assumed that in the slot machine 1, the memory card 53 has already been inserted into the card slot 53S of the gaming board 50 and the GAL 54 has been attached to the IC socket 54S.

First, when the power supply switch of the power supply unit 65 is turned on (power is applied), the mother board 60 and the gaming board 50 are started, respectively, and authentication reading processing of Step (hereinafter, abbreviated to S) 1 is executed. In this authentication reading processing, the mother board 60 and the gaming board 50 perform processings different from each other, concurrently.

That is, in the gaming board 50, the CPU 51 reads-out a preliminary authentication program stored in the boot ROM 52, and according to the readout preliminary authentication program, performs preliminary authentication to confirm and prove that the authentication program has not been falsified before importing the same into the mother board 60.

On the other hand, in the mother board 60, the main CPU 61 develops compressed data installed in the BIOS into the RAM 63 by executing the BIOS stored in the ROM 62, and executes the BIOS developed in the RAM 63 and diagnoses and initializes various peripheral devices.

Thereafter, the main CPU 61 reads-out the authentication program stored in the ROM 55, and performs authentication to confirm and prove that the game program, etc., stored in the memory card 53 inserted in the card slot 53S has not been falsified. When this authentication processing is normally finished, the main CPU 61 writes the game program, etc., that have been subjected to authentication (have been authenticated) on the RAM 63. Subsequently, the CPU performs import processing for reading-out payout ratio setting data stored in the GAL 54 via the gaming board 50, and writes the readout payout ratio setting data on the RAM 63.

After performing the above-described processings, the main CPU 61 ends the authentication reading processing.

Then, at S2, the main CPU 61 successively reads-out the game program, etc., authenticated in the authentication reading processing of S1 from the RAM 63 and executes them, and performs main gaming processing. By executing this main gaming processing, a game is performed in the slot machine 1 of this embodiment. The main gaming processing is then repeated during supply of the power to the slot machine 1.

Next, sub-processing of the main gaming processing of S2 will be described with reference to FIG. 9. FIG. 9 is a flowchart of a main gaming processing program in the slot machine 1 of this embodiment. Each program shown in the flowchart of FIG. 9 is stored in the memory card 53, and is developed in the RAM 63 of the controller 40 and executed by the main CPU 61.

First, as shown in FIG. 9, at S11, the CPU 61 performs a predetermined initial setting and then performs start acceptance processing for accepting coin insertion and setting the number of bets. At this time, in the initial setting, processing such as clearing of data of items set in a predetermined data area (for example, a payout coin counter, etc.,) is performed. In the start acceptance processing, a player performs a bet operation for setting the number of bets in a current game to any of 1 to 50 bets by inserting coins and using the 1-BET button 21 or the MAX-BET button 22.

Next, at S12, the main CPU 61 judges whether the start button 18 has been input. It is judged whether the start button 18 has been input based on whether an input signal has been received from the start switch 18S.

Then, when the start button 18 is not input (S12: NO), the process returns to the start acceptance processing (S11) again. At this time, operations for correcting the number of bets, etc., can be performed. On the other hand, when the start button 18 is input (S12: YES), the number of bets set based on an operation on the 1-BET button 21 or the MAX-BET button 22 is subtracted from the number of credits that the player has and is stored in the RAM 63 as bet information.

Thereafter, at S13, the main CPU 61 executes symbol lottery processing for selecting symbols to be displayed in the respective symbol display areas 31 through 34 of the upper display 5 and the lower display 6 by lottery. In detail, the main CPU 61 samples random numbers from predetermined random number ranges by executing a random number generating program included in the lottery program stored in the RAM 63, and based on the sampled random numbers and the symbol sortition table, determines symbols to be displayed in the symbol display areas 31 through 34 (that is, stop positions of the reels 41 through 44) among the four kinds of divided symbols (see FIG. 3) and blanks for each reel.

Furthermore, at S14, the main CPU 61 starts rotating the reels 41 through 44, and performs scrolling display of symbol rows arranged on the respective reels 41 through 44 at a predetermined speed. Thereafter, when a predetermined time elapses, the rotations of the reels 41 through 44 are stopped in a predetermined order corresponding to the determined effect pattern, and one symbol is displayed on each of the reels 41 through 44 (see FIG. 1).

Herein, when stopping the rotations of the reels 41 through 44, for example, in the case where the second lower reel 44 is to be stopped first, if socks or shoes of the unified symbol 26 (for example, “Woman A”) the prize of which is particularly high are displayed, the player's expectation of the high prize can be increased.

Subsequently, at S15, the main CPU 61 judges whether the unified symbol 26 has been formed by the combination of the divided symbols 25 displayed in the symbol display areas 31 through 34. The slot machine 1 of this embodiment has, as shown in FIG. 3, four kinds of unified symbols 26, and when four divided symbols constituting each unified symbol 26 are all stopped and displayed in the symbol display areas 31 through 34, it is judged that the unified symbol 26 has been formed.

Then, when it is judged that the unified symbol 26 has been formed (S15: YES), the process transfers to S16. On the other hand, when it is judged that the unified symbol 26 has not been formed (S15: NO), the main gaming processing is ended. In order to continuously start a next game, the processings of S1 and subsequent steps are performed again.

At S16, the main CPU 61 performs calculation processing for calculating an award to be awarded as a prize based on the kind of the unified symbol formed by the divided symbols 25 displayed in the symbol display areas 31 through 34. For example, the award is calculated as 1000 credits when the unified symbol 26 of “Woman A” is formed, 500 credits when the unified symbol 26 of “Woman B” is formed, 100 credits when the unified symbol 26 of “Man A” is formed, and 50 credits when the unified symbol 26 of “Man B” is formed.

Next, at S17, the main CPU 61 notifies the player of contents of the prize by displaying the contents of the prize based on the formed combination on the lower display 6. For example, when the unified symbol 26 of “Woman A” is formed, the letters “Win 1000” are displayed to notify that 1000 credits are awarded as a prize.

Subsequently, at S18, it is judged whether a bonus combination has been formed by the combination of the symbols displayed in the symbol display areas 31 through 34 by the reel rotation processing of S14. Herein, the bonus combination is a combination which forms the unified symbol 26 of “Woman A.”

As a result, when it is judged that the bonus combination has been formed (S18: YES), the process transfers to bonus game processing (S19). Various patterns are considered as the bonus game, however, herein, description is given on the assumption that a free game is the bonus game. Herein, the free game is a game in which the same game as the normal game is performed a predetermined number of times without betting, and in the bonus game processing of S21, the rotation and stop control of the reels 41 through 44 is repeated the predetermined number of times, and prizes obtained during this repetition are paid out to the player in the payout processing of S20 described later. As conditions for transfer to the bonus game, various conditions such as display of a predetermined number or more of divided symbols may be set, or the bonus game suddenly may arise as a mystery. As the sortition table to be used in the free game, a sortition table set so that the amount to be paid out is higher than in the normal game may be used.

Then, at S20, the main CPU 61 pays out the award calculated at S16 as a prize to the player. In detail, when the unified symbol 26 is formed by the combination of the divided symbols 25, a prize based on the kind of the formed unified symbol 26 is paid out. For example, when the unified symbol 26 of “Woman A” is formed, 1000 credits are paid out as a prize, when the unified symbol 26 of “Woman B” is formed, 500 credits are paid out as a prize, when the unified symbol 26 of “Man A” is formed, 100 credits are paid out as a prize, and when the unified symbol of “Man B” is formed, 50 credits are paid out as a prize. On the other hand, in the payout processing of S20, when the unified symbol 26 is not formed by the combination of the divided symbols 25, no prize is paid out. At this time, by depressing the CASH-OUT button 20, coins corresponding to the number of credits (one credit corresponds to one coin) can be paid out, or a ticket with a barcode can be paid out.

As described above, in the slot machine 1 of this embodiment, when starting a game, the number of bets in a current game bet by a player's operation by using the 1-BET button 21 or the MAX-BET button 22 is accepted as any of 1 to 50 bets (S11). Thereafter, the first upper reel 41 and the first lower reel 42 arranged on the upper display 5 and the second upper reel 43 and the second lower reel 44 arranged on the lower display 6 start rotating, and after a predetermined time elapses, a total of four divided symbols 25 are stopped and displayed in the symbol display areas 31 through 34 (S14). As a result, particularly when the unified symbol 26 across the symbol display areas 31 through 34 is formed by the combination of the divided symbols 25 displayed, a prize based on the kind of the formed unified symbol is awarded to the player (S20), so that the game result can be notified by using a symbol with a larger size formed across a plurality of displays. Accordingly, the entertainment of the slot machine is improved. Even without increasing the size of the display for displaying the symbol, a game result can be notified by using a larger symbol, so that the game amusement can be remarkably improved in a minimum installation space while keeping the manufacturing cost of the slot machine low.

The divided symbols 25 on the reels 41 through 44 are scrolled in the left and right direction orthogonal to the arrangement direction of the upper display 5 and the lower display 6, so that a unified symbol like a photo montage can be formed by the combination of the divided symbols 25 obtained by dividing the unified symbol at predetermined intervals in the arrangement direction of the displays.

Furthermore, the unified symbol 26 is formed by using the divided symbols 25 arranged on the reels 41 through 44 which are as many as the number of divisions of the unified symbol 26, so that based on various effects using all reels 41 through 44, a symbol with a larger size can be displayed on the displays.

The present invention is not limited to the above-described embodiment, and of course, the present invention can be altered and varied in various ways without departing from the spirit of the present invention.

For example, in this embodiment, in both of the normal game and the bonus game, a game in which the divided symbols 25 and the unified symbol 26 are arranged by using two displays is performed, however, it is also allowed that a game similar to a conventional game using only the lower display 6 is performed during the normal game.

That is, in the slot machine of another embodiment, during the normal game, symbols of “7,”, “BAR,” and “CHERRY,” etc., are scrolled and displayed on the three rows or five rows of reels arranged on the lower display 6. Then, when symbols of the same kind are arranged along a payline, or regardless of a payline, a predetermined number or more of symbols of the same kind are arranged, a prize is awarded. On the other hand, on the upper display 5, during the normal game, symbols are not displayed but a payout table and effect image screens are displayed. During the normal game, the first video controller 1 and the second video controller 72 are asynchronous with each other.

On the other hand, when predetermined conditions are satisfied and the process transfers to a bonus game, as in the embodiment described above, the reels 41 through 44 are provided on the upper display 5 and the lower display 6, divided symbols 25 are scrolled and displayed, and based on whether a unified symbol 26 across the symbol display areas 31 through 34 has been formed, a prize is awarded. During the bonus game, the first video controller 71 and the second video controller 72 are synchronized with each other.

As described above, by arranging the divided symbols 25 or the unified symbol 26 by using two displays only in the bonus game, player's expectation of the bonus game is increased.

In this embodiment, the divided symbols 25 are obtained by dividing the unified symbol 26 into four as many as the reels 41 through 44, however, the unified symbol may be divided into a number smaller than the number of reels 41 through 44. For example, it is allowed that the divided symbols are obtained by dividing the unified symbol into two upper and lower symbols, and by arranging the divided symbols on the first lower reel 42 and the second upper reel 43, the unified symbol is formed.

Furthermore, in this embodiment, an example using video reels as the reels 41 through 44 is described, however, the reels may be mechanical reels. It is also allowed that video reels are used for the first upper reel 41 and the first lower reel 42 to be arranged on the upper display 5, and mechanical reels are used for the second upper reel 43 and the second lower reel 44 to be arranged on the lower display 6. When mechanical reels are used, the divided symbols are arranged on the outer peripheral surfaces of the reels, and the reels are controlled to stop based on a result of internal lottery. When a combination of divided symbols stopped and displayed on the plurality of mechanical reels forms a unified symbol, a prize is awarded.

The present invention is also applicable to a slot machine which employs transparent liquid crystal displays. In this case, a normal game is performed by using mechanical reels arranged on the lower display, and in a bonus game, video reels are newly arranged on the upper display 5 and the lower display and the divided symbols and the unified symbol are arranged by using the respective video reels.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A slot machine comprising:
a controller which controls game progress;
a first display including a first symbol display area which displays a symbol and a first reel which performs scrolling display of a plurality of symbols and stops and displays any one or a plurality of symbols in the first symbol display area; and
a second display which includes a second symbol display area which displays a symbol in an area different from the first symbol display area and a second reel which performs scrolling display of a plurality of symbols and stops and displays any one or a plurality of symbols in the second symbol display area, and is provided separately from the first display, wherein
the controller
displays divided symbols obtained by dividing a unified symbol to be displayed across the first symbol display area and the second symbol display area into a predetermined division number, in the first symbol display area and the second symbol display area, and
awards a prize when the unified symbol is formed by a combination of the divided symbols displayed in the first symbol display area and the second symbol display area.

2. The slot machine according to claim 1, wherein aunified symbol to be displayed across the first symbol display area and the second symbol display area is divided into a total number of the first reel and the second reel.

3. The slot machine according to claim 1, wherein the first reel and the second reel scroll a plurality of symbols leftward or rightward.

4. A slot machine comprising:
a controller which controls game progress;
a first display including a first symbol display area which displays a symbol and a first reel which performs scrolling display of a plurality of symbols in a first direction and stops and displays any one or a plurality of symbols in the first symbol display area; and
a second display which is aligned parallel to the first display in a second direction orthogonal to the first direction, includes a second symbol display area which displays a symbol in an area different from the first symbol display area, and a second reel which performs scrolling display of a plurality of symbols in the first direction and stops and displays any one or a plurality of symbols in the second symbol display area, and is provided separately from the first display, wherein
the controller
displays divided symbols obtained by dividing a unified symbol to be displayed across the first symbol display area and the second symbol display area into a predetermined division number, in the first symbol display area and the second symbol display area, and
awards a prize when the unified symbol is formed by a combination of the divided symbols displayed in the first symbol display area and the second symbol display area.

5. The slot machine according to claim 4, wherein the first reel and the second reel scroll a plurality of symbols leftward or rightward.

6. A slot machine comprising:
a controller which controls game progress;
a first display including a first symbol display area which displays a symbol and one or a plurality of first reels which perform scrolling display of a plurality of symbols in a first direction and stop and display any one or a plurality of symbols in the first symbol display area; and
a second display which is aligned parallel to the first display in a second direction orthogonal to the first direction, includes a second symbol display area that displays a symbol in an area different from the first symbol display area and one or a plurality of second reels that perform scrolling display of a plurality of symbols in the first direction and stop and display any one or a plurality of symbols in the second symbol display area, and is provided separately from the first display, wherein
the controller
displays divided symbols obtained by dividing a unified symbol to be displayed across the first symbol display area and the second symbol display area into a total number of the first reel and the second reel, in the first symbol display area and the second symbol display area, and
awards a prize when the unified symbol is formed by a combination of the divided symbols displayed in the first symbol display area and the second symbol display area.

7. The slot machine according to claim 6, wherein the first reel and the second reel scroll a plurality of symbols leftward or rightward.
